(19) United States
(12) Patent Application Publication
(10) Pub. No.: US 2018/0138479 A1
(43) Pub. Date: May 17, 2018

(54) Power Storage Device

(71) Applicant: Hitachi Automotive Systems, Ltd., Hitachinaka-shi, Ibaraki (JP)

(72) Inventor: Nayuta YAMACHI, Ibaraki (JP)

(21) Appl. No.: 15/572,613

(22) PCT Filed: May 23, 2016
(86) PCT No.: PCT/JP2016/065110

§ 371 Date: Nov. 8, 2017

(30) Foreign Application Priority Data
Jun. 19, 2015 (JP) 2015-124193

(51) Int. Cl. H01M 2/12; H01G 11/80; H01M 2/10; H01M 10/0525; F16K 31/20; F16K 1/12

(52) U.S. Cl. CPC H01M 2/1223; H01G 11/80; H01M 2/1252; H01M 2/1077; B60K 1/04; F16K 31/20; F16K 1/126; H01M 2220/20; H01M 10/0525

(57) ABSTRACT

An object is to obtain a power storage device which can prevent infiltration of a fluid such as water through a gas exhaust tube. A power storage device of the present invention includes a power storage case housing battery cells, a gas exhaust tube communicating between the interior and exterior of the power storage case, and an infiltration prevention mechanism unit preventing a fluid from passing through the gas exhaust tube and infiltrating from the exterior into the interior of the power storage case. The infiltration prevention mechanism unit includes a valve case having a flow path communicating between the interior and exterior of the power storage case, a valve body housed in the valve case and selectively movable to a closed position and an open position, and a guide member guiding the valve body movably in the fluid flow direction.

### TECHNICAL FIELD

The present invention relates to power storage devices,

### BACKGROUND ART

Power storage devices are mounted as power sources in vehicles such as electric vehicles and hybrid vehicles.

A power storage module including a plurality of power storage elements such as lithium ion secondary batteries is housed in the power storage device (see PTL 1).

PTL 1 describes a structure in which gas is discharged to the outside of the module housing through a gas exhaust tube connected to the gas exhaust port when gas is discharged from at least one electric cell (power storage element) of a battery block (power storage module).

### CITATION LIST

### Patent Literature

PTL 1: JP 2013-235827 A

### SUMMARY OF INVENTION

### Technical Problem

Incidentally, when the power storage device is housed in a vehicle compartment corresponding to the living space of the automobile, the exhaust port of the gas exhaust tube described above is installed at a position corresponding to the exterior of the vehicle so as to secure a gas exhaust flow path, thereby sometimes exhausting gas or mist generated in the power storage device to the outside of the vehicle. However, in the case where the exhaust flow path of the power storage device is connected to the outside of the vehicle compartment, or a part of the power storage device communicates with the outside of the vehicle compartment, if the automobile travels through a puddle on a flood road or the like, or is submerged in water by an inundation or a tidal wave, there is a possibility that a fluid such as water will flow into the power storage device as foreign matter by being transmitted through the above-described exhaust tube.

If fluid such as water enters the power storage device, there is a possibility that the performance deterioration or malfunctions of the power storage device will occur. Therefore, it is necessary to prevent fluid from entering the power storage device through the gas exhaust tube.

The present invention has been made in view of the above points. An object of the present invention is to provide a power storage device capable of preventing fluid such as water from passing through a gas exhaust tube to infiltrate.

### Solution to Problem

A power storage device of the present invention to solve the above issue includes: a power storage case which houses a battery cell; a gas exhaust tube which communicates between an inside and an outside of the power storage case; and an infiltration prevention mechanism unit which prevents fluid from entering the inside from the outside of the power storage case through the gas exhaust tube, wherein the infiltration prevention mechanism unit includes: a valve case which is connected to the gas exhaust tube and has a flow path communicating between the inside and the outside of the power storage case; a valve body which is housed in the valve case and is selectively movable to a closed position in which the flow path is closed and an open position in which the flow path is opened; and a guide member which guides the valve body movably in a flowing direction of the fluid.

### Advantageous Effects of Invention

According to the present invention, the infiltration of fluid such as water from the outside into the inside of the power storage case through the gas exhaust tube can be reliably prevented.

### BRIEF DESCRIPTION. OF DRAWINGS

FIG. 1 is an exploded perspective view of an embodiment of a power storage device according to the present invention.

FIG. 2 is a perspective view of a gas exhaust tube.

FIG. 3 is a schematic cross-sectional view showing a lower end side attachment section of the gas exhaust tube.

FIG. 4 is a view of an upper end side attachment section as seen from the front.

FIG. 5 is a schematic cross-sectional view showing an infiltration prevention mechanism unit.

FIG. 6 is a view of an exhaust flow path as viewed from above.

FIG. 7 is a view showing an exhaust flow path of an infiltration prevention mechanism unit according to a modification example.

FIG. 8 is a view showing an infiltration prevention mechanism unit according to a modification example.

FIG. 9 is an enlarged cross-sectional view of a main part of an infiltration prevention mechanism unit according to a modification example.

FIG. 10 is a view showing an infiltration prevention mechanism unit according to a modification example.

### DESCRIPTION OF EMBODIMENTS

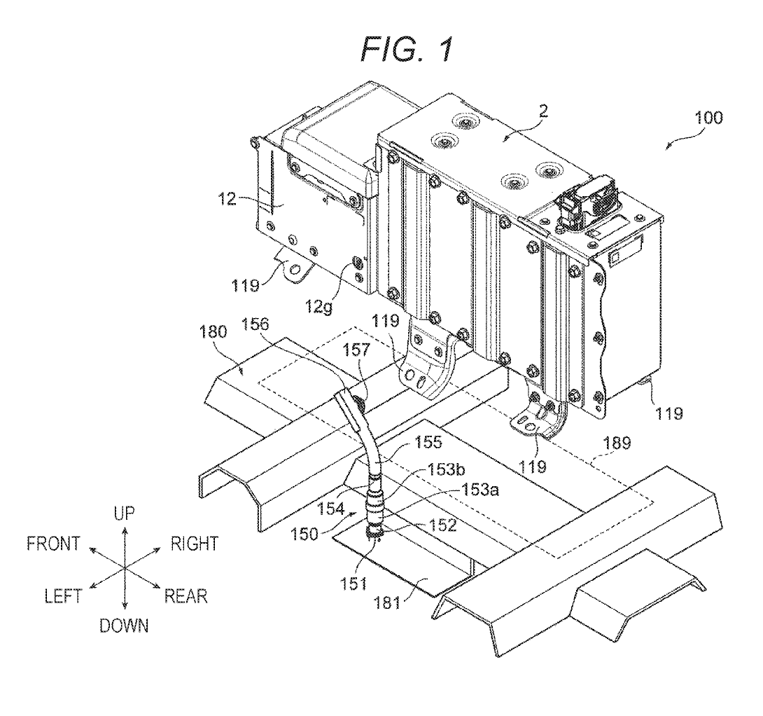

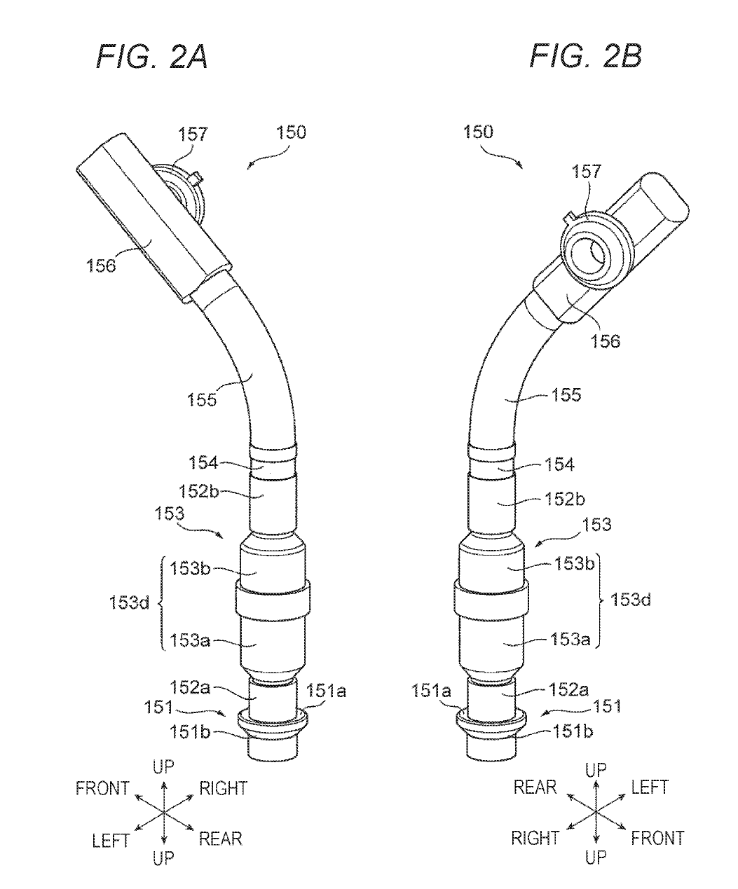

An embodiment of a power storage device according to the present invention will be described with reference to the drawings. FIG. 1 is an exploded perspective view of one embodiment of the power storage device according to the present invention. In the following description, description will be made regarding the front-rear direction, right-left direction, and up-down direction as the directions illustrated in FIGS. 1 and 2.

A power storage device 100 according to the present embodiment is applied to an in-vehicle power supply device in an electric motor drive system of electric vehicles (for example, electric automobiles). The concept of an electric vehicle includes a hybrid electric vehicle having an engine, which is an internal combustion engine, and an electric motor, as drive sources of a vehicle, and a genuine electric vehicle using an electric motor as the sole drive source of a vehicle.

A vehicle body structure 180 schematically shown in FIG. 1 is a member constituting the skeleton (frame) of a vehicle. The power storage device 100 is fixed on the vehicle body structure 180 by brackets 119.

The power storage device 100 is, for example, a lithium ion battery device, and a plurality of power storage modules each having a plurality of secondary batteries such as lithium-ion batteries as power storage elements are housed in a power storage case 2 as a housing of the power storage device 100. The power storage case 2 is composed of a plurality of members, and the gaps between the members are sealed with an adhesive, a packing, or the like. The power storage module housed in a hermetically sealed space sealed by the power storage case 2.

The power storage case 2 is provided with a gas exhaust port 12g, and a gas exhaust tube 150 is attached thereto. When a cleavage groove of at least one secondary battery of the plurality of secondary batteries in the power storage device 100 is opened and gas is discharged into the power storage case 2, the discharged gas flows from the gas exhaust port 12g of the power storage case 2 into the gas exhaust tube 150, and is exhausted from the gas exhaust tube 150 to the outside of the power storage case 2.

The gas exhaust tube 150 is arranged so as to extend in the vertical direction, an upper end side attachment section 157 is connected to the gas exhaust port 12g, and a lower end side attachment section 151 is held on a mounting plate 181 of the vehicle body structure 180. The gas discharged from the gas exhaust port 12g passes through the flow path inside the gas exhaust tube 150 and is guided to a predetermined position in the vehicle. Then, the gas guided to the predetermined position in the vehicle is discharged to the outside of the vehicle through the gas exhaust duct (not shown) of the vehicle body structure 180.

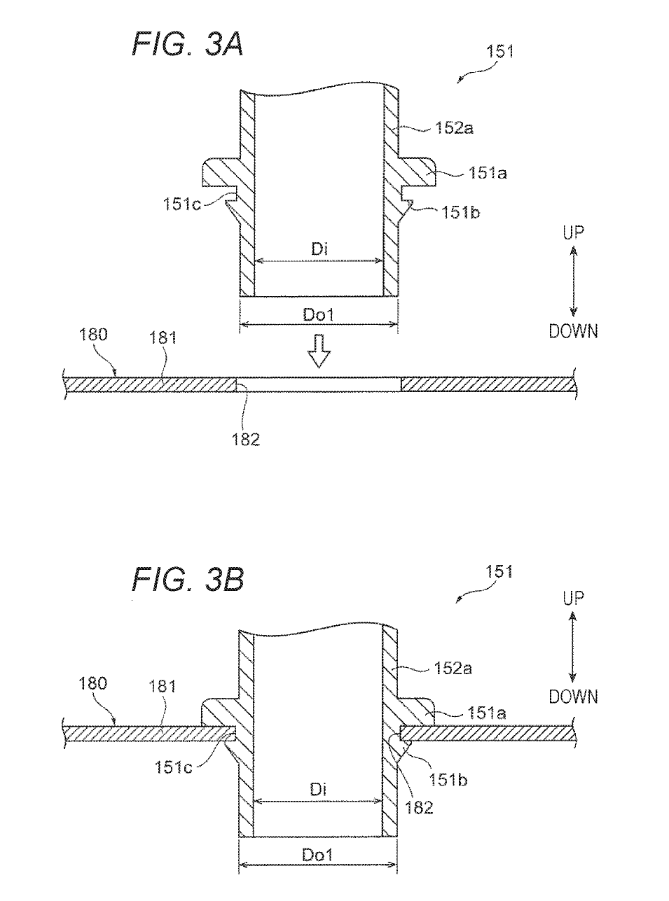

As shown in FIG. 1, the gas exhaust tube 150 is attached and supported in a state of standing substantially perpendicularly to the mounting plate 181 of the vehicle body structure 180. The mounting plate 181 is a flat metal plate. The gas exhaust tube 150 is a flow path forming body with a flow path having a circular cross section in its inside, and is a tube formed in a substantially cylindrical shape and having an inner diameter Di (see FIG. 3). The material of the gas exhaust tube 150 is chloroprene rubber (CR), for example.

FIG. 2 is a perspective view of the gas exhaust tube. FIG. 2 (a) is a perspective view of the gas exhaust tube 150 as viewed from one side, and FIG. 2(b) is a perspective view of the gas exhaust tube 150 of FIG. 2 (a) as viewed from another direction.

As shown in FIGS. 2 (a) and 2 (b), the gas exhaust tube 150 is connected to an infiltration prevention mechanism unit 153 in the flow path. The gas exhaust tube 150 includes the lower end side attachment section 151 provided on the lower end side, a linear cylindrical portion 152a extending upward (roughly in the vertical direction) from the lower end side attachment section 151, the infiltration prevention mechanism unit 153 provided at an intermediate position of linear cylindrical portions 152a and 152b, a deformation section 154 provided at the upper end of the linear cylindrical portion 152b, a curved cylindrical section 155 curved toward the upper front from the deformation section 154, a weight section 156 provided at the upper end of the curved cylindrical section 155, and the upper end side attachment section 157 provided at the right side portion of the weight section 156. The linear cylindrical portions 152a and 152b, and the curved cylindrical section 155 have outer diameters of Dol (see FIG. 3).

The lower end side attachment section 151 is a section attached to the mounting plate 181 of the vehicle body structure 180. The infiltration prevention mechanism unit 153 is provided at an intermediate position of the linear cylindrical portions 152a and 152b. The infiltration prevention mechanism unit 153 has a structure that prevents fluid from entering the inside from the outside of the power storage case 2 by passing through the gas exhaust tube 150. The structure of the infiltration prevention mechanism unit 153 will be described later in detail.

The deformation section 154 has a small section modulus and a small second moment of area in a cross section perpendicular to the gas flow direction in the gas exhaust tube 150, as compared with the linear cylindrical portions 152a and 152b and the curved cylindrical section 155, and is formed to be a part having a small bending rigidity, that is, a part which is easily bent and deformed.

The curved cylindrical section 155 functions as a connecting section connecting the weight section 156 and the deformation section 154. Since the curved cylindrical section 155 is curved toward the upper front, the position of the center of gravity of the gas exhaust tube 150 is positioned on the front side of the deformation section 154.

The weight section 156 is formed so that the mass per unit length thereof is larger than that of each of the linear cylindrical portions 152a and 152b, and the curved cylindrical section 155.

FIG. 3 is a schematic cross-sectional view showing the lower end side attachment section 151. FIG. 3 (a) shows a state before the lower end side attachment section 151 is attached to the mounting plate 181 of the vehicle body structure 180, and FIG. 3 (b) shows a state in which the lower end side attachment section 151 has been attached to the mounting plate 181 of the vehicle body structure 180. The lower end side attachment section 151 has an annular flange 151a and an annular engaging protrusion 151b.

Each of the flange 151a and the engaging protrusion 151b is provided so as to radially protrude outward from the linear cylindrical portion 152a in order to have a diameter larger than the outer diameter Dol of the linear cylindrical portion 152a. The flange 151a and the engaging protrusion 151b are separated by a distance substantially the same as the thickness of the mounting plate 181 of the vehicle body structure 180 and a groove 151c is formed as the space between the flange 151a and the engaging protrusion 151b. The engaging protrusion 151b disposed under the flange 151a has a tapered shape in which the outer diameter gradually increases from the lower end side toward the upper side.

A mounting hole 182 which is a circular through hole is provided in the mounting plate 181 of the vehicle body structure 180, and the lower end side attachment section 151 of the gas exhaust tube 150 is inserted into the mounting hole 182 so that the groove 151c is fitted with the opening periphery of the mounting hole 182, whereby the gas exhaust tube 150 is attached to the vehicle body structure 180. Thus, the gas exhaust tube 150 is attached so that the opening periphery of the mounting hole 182 is sandwiched between the flange 151a and the engaging protrusion 151b of the lower end side attachment section 151, and is supported by the vehicle body structure 180.

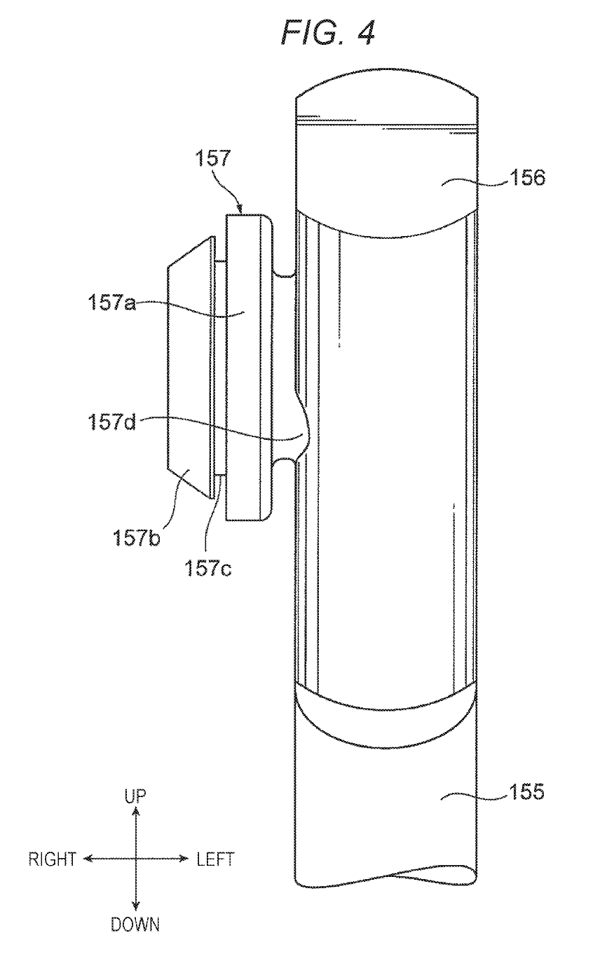

FIG. 4 is a view of the upper end side attachment section 157 as viewed from the front. The upper end side attachment section 157 has an annular flange 157a and an annular engaging protrusion 157b. The upper end side attachment section 157 and the right side face of the weight section 156 are connected by a connecting tube 157d. The flange 157a and the engaging protrusion 157b are separated by a distance substantially the same as the thickness of a side cover 12 of the power storage device 100, and a groove 157c is formed as the space between the flange 157a and the engaging protrusion 157b. The outer diameter of the bottom of the groove 157c is smaller than the outer diameter of each of the flange 157a and the engaging protrusion 157b. It should be noted that the engaging protrusion 157b disposed on the right side of the flange 157a has a tapered shape such that its outer diameter gradually increases from the right end side to the left side.

The upper end side attachment section 157 of the gas exhaust tube 150 is inserted into the gas exhaust port 12g of the side cover 12 so that the opening periphery of the gas exhaust port 12g is fitted into the groove 157c, whereby the gas exhaust tube 150 is attached to the power storage device 100. The gas exhaust tube 150 is attached so that the opening periphery of the gas exhaust port 12g is sandwiched between the flange 157a and the engaging protrusion 157b of the upper end side attachment section 157.

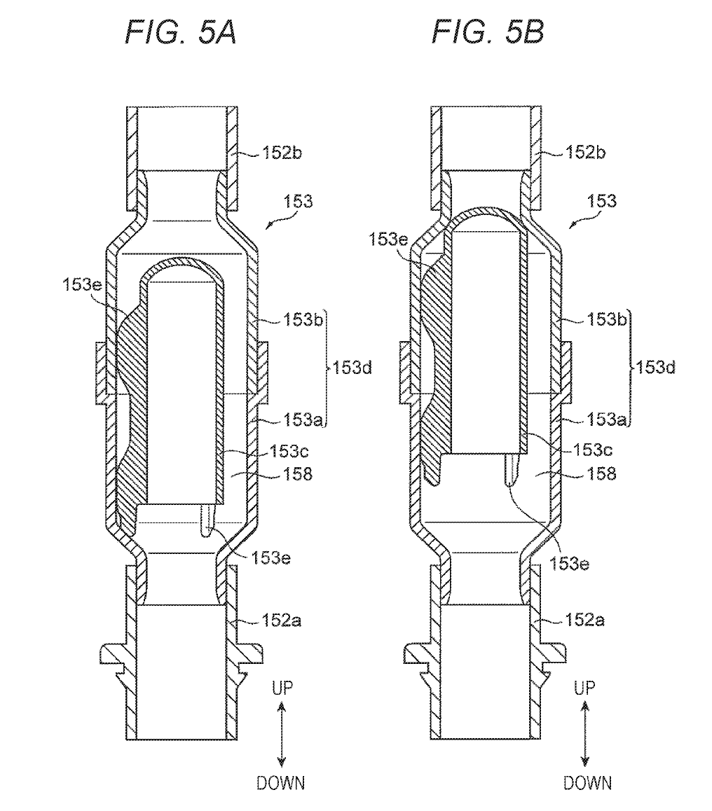

FIG. 5 is a schematic cross-sectional view showing the infiltration prevention mechanism unit 153. FIG. 5 (a) shows a normal state diagram of the gas exhaust tube 150, that is, a non-operating state of the infiltration prevention mechanism unit 153, and FIG. 5(b) shows a state at the time of backflow prevention, that is, an operating state of the infiltration prevention mechanism unit 153. The infiltration prevention mechanism unit 153 includes a cylindrical valve case 153d, a non-penetrated cylindrical valve body 153c, and a guide member 153e which guides the valve body 153c movably in the flow direction of the fluid in the valve case 153d.

The valve case 153d has a gas exhaust flow path (flow path) 158 which is connected to the gas exhaust tube 150 and communicates between the inside and the outside of the power storage case 2. An end on one side of the valve case 153d in the axial direction communicates with the inside of the power storage case 2, and an end on the other side of the valve case 153d in the axial direction communicates with the outside. The gas exhaust flow path 158 is provided in the axial direction of the valve case 153d.

The valve body 153c is housed in the valve case 153d to be capable of being selectively positioned in a closed position for closing the gas exhaust flow path 158 and an open position for opening the gas exhaust flow path 158. The valve body 153c is positioned at the closed position by being moved to one side in the axial direction and is positioned at the open positions by being moved to the other side in the axial direction. The valve body 153c is moved from the open position to the closed position by the fluid entering from the outside of the power storage case 2. The guide member 153e is disposed between the valve case 153d and the valve body 153c, and guides the valve body 153c so as to be capable of reciprocating movement between the closed position and the open position in the axial direction of the valve case 153d.

The valve case 153d is composed of a lower case 153a and an upper case 153b. In the present embodiment, the valve case 153d is arranged almost vertically so as to extend upward and downward in the axial direction by arranging the upper case 153b which is an end on one side of the valve case 153d in the axial direction to be higher than the lower case 153a which is an end on the other side of the valve case 153d in the axial direction. The lower case 153a and the linear cylindrical portion 152a on the lower side are connected to communicate with each other, and the upper case 153b and a linear cylindrical portion 152b on the upper side are connected to communicate with each other.

The lower case 153a has a small-diameter portion connected to the linear cylindrical portion 152a, a tapered portion whose diameter gradually increases as being apart from the small-diameter portion in the axial direction, and a large-diameter portion continuous with the tapered portion and extending in the axial direction while having a constant diameter.

The upper case 153b has a small-diameter portion connected to the linear cylindrical portion 152b, a tapered portion whose diameter gradually increases as being apart from the small-diameter portion in the axial direction, and a large-diameter portion continuous with the tapered portion and extending in the axial direction while having a constant diameter. When viewed from the lower case 153a side, the upper case 153b includes a large-diameter portion having the same diameter as that of the large-diameter portion of the lower case 153a and continuous with the large-diameter portion, a tapered portion whose diameter gradually reduces from the large-diameter portion, and a small-diameter portion continuous with the tapered portion and extending while having a constant diameter in the axial direction and connected to the linear cylindrical portion 152b.

The small-diameter portion of the lower case 153a and the small-diameter portion of the upper case 153b have the same inner diameter. The large-diameter portion of the lower case 153a and the large-diameter portion of the upper case 153b have the same inner diameter. The valve case 153d is assembled by joining the large-diameter portion of the lower case 153a and the large-diameter portion of the upper case 153b so as to connect the upper case 153b continuously to the upper part of the lower case 153a, and forms a continuous valve chamber having a constant inner diameter in the axial direction therein.

The valve body 153c is housed in the valve chamber of the valve case 153d and is always in contact with the inner circumferential surface of the valve case 153d via the guide member 153e, which maintains the posture of the valve body 153c. That is, since the center axis of the valve case 153d and the center axis of the valve body 153c coincide with each other, the valve body 153c can move only in the axial direction. The material of the infiltration prevention mechanism unit 153 is a polyphenylene sulfide (PPS).

The valve body 153c has an outer diameter dimension smaller than the sizes of the large-diameter portions of the lower case 153a and the upper case 153b, and larger than the sizes of the small-diameter portions of the lowercase 153a and the upper case 153b, and has an axial length so as to extend from the region on the lower case 153a side to the region on the upper case 153b side and to be reciprocally movable in the axial direction in the valve chamber formed by the valve case 153d. The upper end of the valve body 153c is closed, and has a contact portion having a spherically convex shape.

Since the valve body 153c has a cylindrical shape whose upper end is closed, when a fluid such as water enters the valve chamber of the valve case 153d from below, air is accumulated in the valve body 153c, and buoyant force is generated. Then, due to the buoyant force of the air, the valve body. 153c moves upward in the valve chamber of the valve case 153d, and the contact portion comes into contact with the tapered portion of the upper case 153b to close the gas exhaust flow path 158 of the valve case 153d. On the other hand, in the normal state, the valve body 153c is positioned in the lower side of the valve chamber by its own weight, and the contact portion is separated from the tapered portion of the upper case 153b to open the gas exhaust flow path 158 of the valve case 153d.

In the present embodiment, the linear cylindrical portion 152a on the vehicle body structure 180 side is connected to the lower portion of the valve case 153d so as to be continuous in the axial direction of the valve case 153d. Thus, when a fluid intrudes into the valve case 153d from the lower part of the valve case 153d, external force can be applied directly to the valve body 153c in the valve case 153d. Hence, the gas exhaust flow path 158 can be closed to block out not only the liquid such as water, but also a certain amount of gas flowing into the valve case 153d, by allowing the valve body 153c to float. Accordingly, the dust, for example, mixed with the gas can be prevented from flowing into the power storage case 2.

The guide member 153e may be provided on at least one of the valve case 153d and the valve body 153c and is provided on the valve body 153c in the present embodiment. The guide member 153e is constituted by a plurality of plate-shaped outer ribs that radially protrude outward in radial directions from the outer peripheral surface of the cylindrical portion of the valve body 153c and that extend in the axial direction of the valve body 153c. Three outer ribs of the guide member 153e are provided at angular intervals of 120 degrees from each other, but the number of the outer ribs is not limited to three, and the number may be two, four or more for example, as long as the valve body 153c can be guided to be movable in the axial direction of the valve case 153d.

The upper end of the outer ribs of the guide member 153e is located at an offset position shifted downward from the upper end of the cylindrical portion of the valve body 153c in order to avoid interference with the tapered portion of the upper case 153b when the valve body 153c moves upward. On the other hand, the lower ends of the outer ribs of the guide member 153e protrude downward from the valve body 153c so that the lower ends of the outer ribs come in contact with the tapered portion of the lower case 153a and always opens the valve when the valve body 153c has moved downward.

The outer rib of the guide member 153e has a shape in which the upper portion and the lower portion radially protrude outward and the intermediate portion is radially recessed inward. The lower portion of the guide member 153e is opposed to and in contact with the inner circumferential surface of the lower case 153a, and the upper portion of the guide member 153e is opposed to and in contact with the inner circumferential surface of the upper case 153b. The intermediate portion of the guide member 153e is disposed at a position shifted toward the center in the radial direction of the valve body 153c apart from the joint between the lower case 153a and the upper case 153b. When the valve body 153c moves in the vertical direction in the valve case 153d, the guide member 153e is prevented from coming in contact with and being caught by the joint between the lower case 153a and the upper case 153b, in order to allow the valve body 153c to move smoothly.

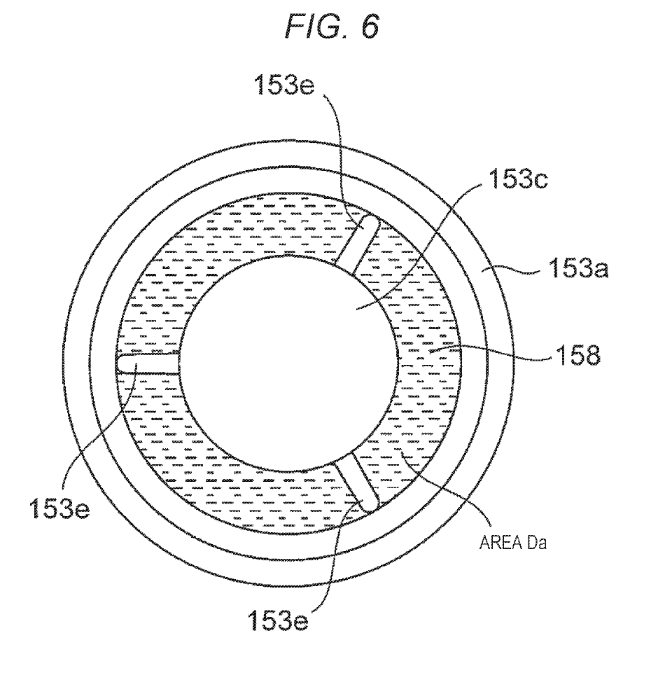

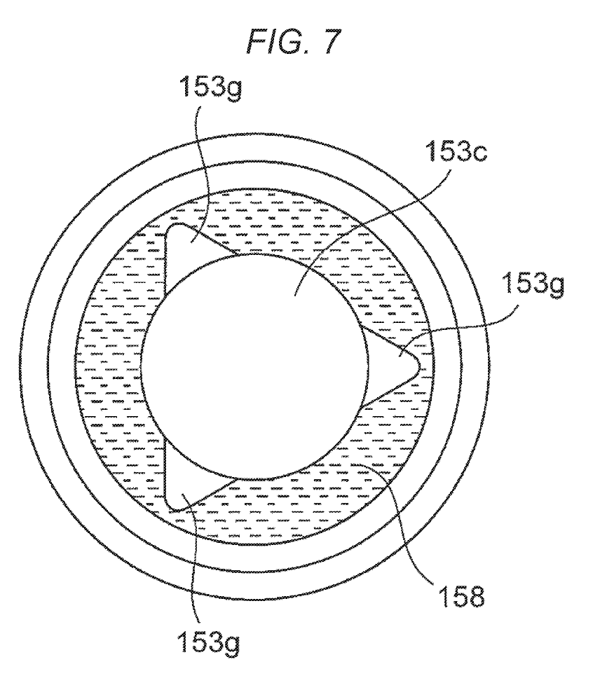

FIG. 6 is a view in which only the lower case 153a and the valve body 153c are viewed from above. The gas exhaust flow path 158 is formed in the valve case 153d due to the difference between the cylinder inner diameter of the lower case 153a and the cylindrical outer diameter of the valve body 153c. The flow path area Da of the gas exhaust flow path 158 is equal to or greater than the area of the flow path formed in a substantially cylindrical shape having the inner diameter Di (Da ≥Di), and the resistance of the exhaust flow path can be suppressed. The rib constituting the guide member is not limited to a plate-shaped rib as shown in FIG. 6, and a guide member 153g may be provided having ribs each being a triangular-pole-shaped protrusion, for example, as shown in FIG. 7.

In the present embodiment, even when the valve body 153c is housed in the infiltration prevention mechanism unit 153, the gas exhaust flow path 158 is always opened and a flow path is secured. Accordingly, even low-pressure gas or mist generated inside the power storage device can pass through and can be guided smoothly to a predetermined position to be discharged.

Next, the effect of the infiltration prevent ion mechanism unit in the present embodiment will be described. As described above, for example, in the case where the automobile travels through a submerged road or the like and the periphery of the vehicle body structure 180 is covered with a fluid such as water, the fluid enters the gas exhaust tube 150 from below the lower end side attachment section 151. The fluid passes through the linear cylindrical portion 152a from the lower end side attachment section 151 and reaches the infiltration prevention mechanism unit 153.

When the fluid reaches the infiltration prevention mechanism unit 153, buoyant force is generated by the air accumulated inside the cylindrical portion of the valve body. 153c, and due to the buoyant force, the valve body 153c moves upward in the axial direction in the valve case 153d. Then, the upper end of the valve body 153c comes into contact with the tapered portion of the upper case 153b to close the gas exhaust flow path 158. Thus, the fluid that has entered from the linear cylindrical portion 152a can be stopped in the gas exhaust flow path 158 and the fluid can be prevented from reaching the linear cylindrical portion 152b on the power storage case 2 side of the infiltration prevention mechanism unit 153. Accordingly, the infiltration prevention mechanism unit 153 blocks the flow path of the gas exhaust tube 150, and can prevent the fluid from entering the power storage device 100.

When the fluid has been removed from the gas exhaust flow path 158 because the automobile has escaped from a submerged road or due to some reasons, and an external force has been eliminated, the valve body 153c descends due to its own weight for automatic reset and so as to be separated from the tapered portion of the upper case 153b to open the valve. Accordingly, the flow path of the gas exhaust tube 150 can be opened, and the gas exhausted from the power storage device 100 can be discharged.

Whether or not the valve body 153c is moved by external force to block the exhaust flow path, in other words, whether or not the infiltration prevention mechanism unit 153 can prevent the infiltration of the fluid is determined by the material of the valve body 153c, buoyant force depending on the outer diameter and the inner diameter of the valve body 153c, mass of the valve body 153c, and friction resistance by the valve body 153c, the lower case 153a and the upper case 153b, and the like.

As described above, the diameter of the cylindrical portion of the valve body 153c, and the inner diameter Di of the part formed in a substantially cylindrical shape, and the mass of the valve body 153c are determined so that the gas exhaust flow path 158 is secured, the gas exhaust flow path 158 is closed by the buoyancy of the valve body 153c and external force to prevent infiltration, in the present embodiment.

According to the above-described embodiment., the following operational effects can be obtained. The gas exhaust tube 150 has the infiltration prevention mechanism unit 153 for preventing infiltration of fluid from the outside, and the infiltration mechanism unit 153 includes the valve case 153d disposed so that the axis thereof extends in the vertical direction, the valve body 153c housed in the valve case 153d, and the guide member 153e which guides the valve body 153c movably only in the axial direction of the valve case 153d.

Then, the valve body 153c is opened by its own weight, and when pressure is applied to the valve body 153c from the outside, the valve body 153c is floated by the external pressure. At that time, the valve body 153c is guided in the axial direction of the valve case 153d by the guide member 153e, thereby closing the valve.

Therefore, the gas exhaust flow path 158 can be reliably closed by guiding and moving the valve body 153c in the axial direction to close the valve without being affected by the direction in which the fluid enters the valve case 153d and the degree of the fluid force. Accordingly, even in a place where the fluid enters from the outside, the storage position of the power storage device 100 and the attachment position of the gas exhaust tube 150 are not limited and can be in various places.

The following modifications are also within the scope of the present invention, and one or more of the modifications can also be combined with the above-described embodiment.

### MODIFICATION EXAMPLE 1

In the above-described embodiment, the configuration in which the guide member 153e is provided on the valve body 153c has been described, but the present invention is not limited thereto. The guide member may be provided on at least one of the valve body 153c and the valve case 153d.

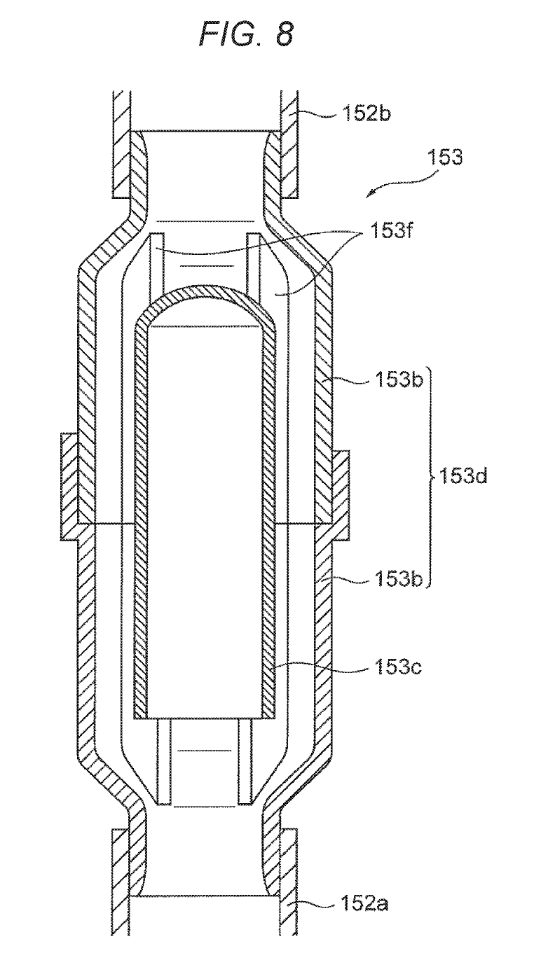

FIG. 8 is a view showing an infiltration prevention mechanism unit according to a modification example. For example, a guide member 153f may be provided on the valve case 153d, as shown in FIG. 8. In the case of the structure shown in FIG. 8, the valve body 153c can have a simple shape with small mass.

The guide member 153f is constituted by plate-shaped inner ribs protruding from the inner peripheral surface of the valve case 153d toward the central axis. The plurality of inner ribs are provided at predetermined intervals in the circumferential direction. The valve body 153c has a cylindrical portion, and the outer peripheral surface of the cylindrical portion is in contact with the inner ribs of the guide member 153f provided on the valve case 153d, and thereby the valve body 153c is guided only in the axial direction so as to be able to reciprocate vertically in the valve chamber of the valve case 153d.

### MODIFICATION EXAMPLE 2

In the embodiment described above, the structure in which the upper end of the cylindrical portion of the valve body 153c comes into contact with the tapered portion of the upper case 153b to close the valve chamber has been described, and then the upper end of the cylindrical portion has a spherically convex contact portion and makes line contact with the tapered portion. Therefore, in order to block more reliably, the configuration may be made to have surface contact.

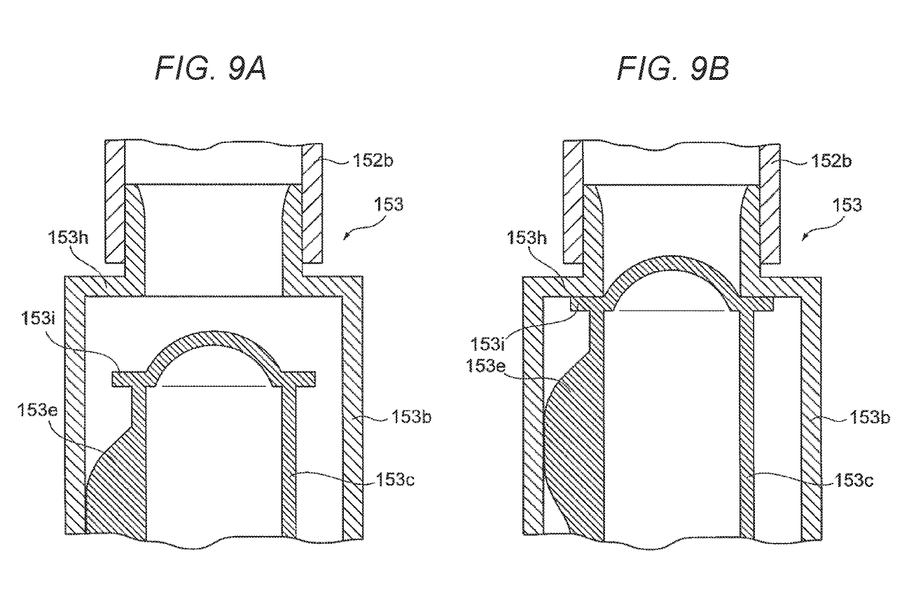

FIG. 9 is a schematic cross-sectional view showing an enlarged main part of an infiltration prevent ion mechanism unit according to a modification example. FIG. 9(a) shows a normal state diagram of the gas exhaust tube 150, that is, a non-operating state of the infiltration prevention mechanism unit 153, and FIG. 9(b) shows a state at the time of back-flow prevention, that is, an operating state of the infiltration prevention mechanism unit 153.

The upper case 153b has a flat portion 153h expanding in a direction perpendicular to the axial direction, instead of the tapered portion. The valve body 153c has a flange 153i radially protruding outward from the upper end and facing the flat portion 153h circumferentially and continuously.

In the non-operating state of the infiltration prevention mechanism unit 153, the valve body 153c has moved downward due to its own weight, and the flat portion 153h of the upper case 153b and the flange 153i of the valve body 153c are apart from each other so that the gas exhaust flow path 158 is open, as shown in FIG. 9(a). On the other hand, in the operating state of the infiltration prevention mechanism unit 153, as shown in FIG. 9(b), the valve body 153c floats and moves upward and the flat portion 153h of the upper case 153b and the flange 153i of the valve body 153c make surface contact with each other so that the gas exhaust flow path 158 is closed.

Therefore, the flat portion 153h of the upper case 153b and the flange 153i of the valve body 153c can make surface contact with each other, so that the contact area can be made larger than in the above-described embodiment. Accordingly, the exhaust path can be reliably closed, and the fluid can be prevented from flowing into the power storage case 2.

### MODIFICATION EXAMPLE 3

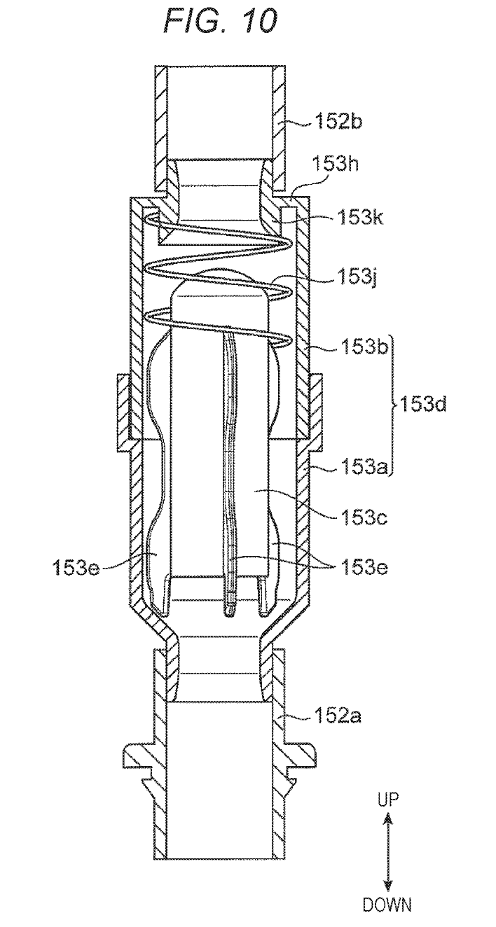

FIG. 10 is a view showing an infiltration prevention mechanism unit according to another modification. In the above-described embodiment, although the case where the valve body 153c is disposed at a lower position in the valve case 153d by its own weight has been described, a configuration may be adopted in which the valve body 153c is urged downward by providing an urging device. A spring 153j having urging force to the extent that upward movement of the valve body 153c due to buoyancy is not obstructed can be used as the urging device.

The spring 153j is interposed between the flat portion 153h of the upper case 153b and the guide member 153e of the valve body 153c, for example, and urges the valve body 153 from the upper side that is one side in the axial direction of the valve case 153d toward the lower side that is the other side in the axial direction. The upper case 153b has a cylindrical portion 153k that protrudes in the axial direction from the flat portion 153h toward the inside of the case. The cylindrical portion 153k has a tapered inner peripheral surface whose inner diameter increases toward the tip side, and is closed by the contact with the upper end of the valve body 153c.

According to such a configuration, the valve body 153c can be held at the open position by the urging force of the spring 153j in the normal state. Therefore, for example, when the power storage device 100 is mounted in the vehicle, the valve body 153c can be prevented from generating sound or fatigue failure due to vibration during traveling. When fluid enters from below the valve case 153d, the valve body 153c moves upward against the urging force of the spring 1531 due to buoyancy, and is disposed at the closed position, and then the upper end of the valve body 153c comes in contact with the tapered inner peripheral surface of the cylindrical portion 153k to close the gas exhaust flow path 158, and can prevent fluid from entering.

In the embodiment described above, the input position of the external force applied to the infiltration prevention mechanism unit 153 is set under the valve case 153d so that even a certain amount of flowing gas allows the valve body 153c to float by causing the external force to be applied directly to the valve body 153c, but the present invention is not limited to this. That is, a hole may be formed in a side surface of the valve case 153d of the infiltration prevention mechanism unit 153 so that a buoyant force is generated on the valve body 153c by a liquid flowing into the infiltration prevention mechanism unit 153, and thereby back flow can be prevented.

In the above-described embodiment, the case where the infiltration prevention mechanism unit 153 is vertically held so as to extend in the up-and-down direction is described as an example, but the present invention is not limited thereto. The valve case 153d may be arranged obliquely, as long as the end of the infiltration prevention mechanism unit 153 on the power storage case 2 side is disposed higher than the end on the vehicle body structure 180 side.

In the above-described embodiment, the infiltration prevention mechanism unit 153 is described as an example of a resin structure made of three components, but the present invention is not limited thereto. For example, contact sound may be reduced by using a material such as rubber or sponge for a contact surface between the valve body 153c and the tube. Further, the number of components may be reduced by forming the cylindrical portion as one component.

In the above-described embodiment, although the lithium ion secondary battery is described as an example of the power storage element, the present invention can be applied to other secondary batteries such as a nickel hydrogen battery. Furthermore, the present invention can also be applied to a case where an electric double layer capacitor or a lithium ion capacitor is used as the power storage element.

Further, in the above-described embodiment, an example in which the present invention is applied to an electric vehicle has been described, but the present invention is not limited thereto. The present invention can also be applied to a power storage device constituting a vehicle power supply device for a railway vehicle such as a hybrid electric train, a motor-omnibus such as a bus, a motor-lorry such as a truck and an industrial vehicle such a battery type forklift truck as other electric vehicles.

Although embodiments of the present invention have been described above in detail, the present invention is not limited to the above-described embodiments, and various design changes can be made without departing from the spirit of the present invention described in the claims. For example, the above-described embodiments have been described in detail for the purpose of easy-to-understand description of the present invention, and embodiments are not necessarily limited to those having all the configurations described above. In addition, a part of the configuration of an embodiment can be replaced by a configuration of another embodiment, and a configuration of an embodiment can be added to a configuration of another embodiment. Furthermore, addition of another configuration, deletion, or replacement by another configuration can be carried out with respect to part of the configuration of each embodiment.

### REFERENCE SIGNS LIST

power storage case
100 power storage device
150 gas exhaust tube
151 lower end side attachment section.
153 infiltration prevention mechanism unit
153a lower case
153b upper case
153c valve body
153d valve case
153e, 153g guide member (outer rib)
153f guide member (inner rib)
153h flat portion
153i flange
153j spring (urging device)
158 gas exhaust flow path
180 vehicle body structure
181 mounting plate

1. A power storage device comprising:
a power storage case which houses a battery cell;
a gas exhaust tube which communicates between an inside and an outside of the power storage case; and
an infiltration prevention mechanism unit which prevents fluid from entering the inside from the outside of the power storage case through the gas exhaust tube,
wherein the infiltration prevention mechanism unit includes:
a valve case which is connected to the gas exhaust tube and has a flow path communicating between the inside and the outside of the power storage case;
a valve body which is housed in the valve case and is selectively movable to a closed position in which the flow path is closed and an open position in which the flow path is opened; and
a guide member which guides the valve body movably in a flowing direction of the fluid.

2. The power storage device according to claim 1, wherein the valve case has a cylindrical shape, an end on one side of the valve case in an axial direction communicates with the inside of the power storage case and an end on another side of the valve case in the axial direction communicates with the outside of the power storage case, and the flow path is provided in the axial direction of the valve case,
the valve body is disposed at the closed position by moving to the one side in the axial direction, and is disposed at the open position by moving to the other side in the axial direction, and
the guide member is provided on at least one of the valve case and the valve body, and guides the valve body movably in the axial direction of the valve case.

3. The power storage device according to claim 2, wherein a flow path area between the valve case and the valve body is equal to or greater than a flow path area of the gas exhaust tube.

4. The power storage device according to claim 3, wherein the valve case is disposed such that the end on the one side of the valve case in the axial direction is positioned higher than the end on the other side of the valve case in the axial direction, and
the valve body is configured such that when fluid enters the valve case from the end on the other side in the axial direction, the valve body is moved upward by buoyant force to be disposed at the closed position.

5. The power storage device according to claim 4, comprising an urging device which urges the valve body from the one side of the valve case in the axial direction toward the other side of the valve case in the axial direction.

6. The power storage device according to claim 5, wherein the valve case has a tapered portion whose diameter gradually decreases toward the end on the one side in the axial direction, and
the valve body has a contact portion having a spherically convex shape, which comes in contact with the tapered portion of the valve case at the closed position to close the flow path.

7. The power storage device according to claim 5, wherein the end on the one side of the valve case in the axial direction has a flat portion extending in a direction perpendicular to the axial direction, and
the valve body has a flange which makes surface contact with the flat portion of the valve case at the closed position to close the flow path.

8. The power storage device according to claim 4, wherein the valve body has a cylindrical shape, and
the guide member includes at least either a plurality of outer ribs or a plurality of inner ribs, the plurality of outer ribs radially protruding outward in radial directions from an outer peripheral surface of the valve body, the plurality of inner ribs protruding from the inner peripheral surface of the valve case toward a center in radial directions and being arranged at predetermined intervals in a circumferential direction.

9. The power storage device according to claim 4, wherein the valve case includes a lower case and an upper case connected to an upper part of the lower case in a continuous manner,
the valve body has a length extending from the lower case to the upper case,
the guide member has a plurality of outer ribs radially protruding outward in radial directions from the outer peripheral surface of the valve body, and
the outer ribs each includes:
a lower portion which is in contact with the lower case;
an upper portion which is in contact with the upper case; and
an intermediate portion which is disposed at a position shifted toward a center in radial directions of the valve body apart from a joint between the lower case and the upper case.
